(19) United States
(12) Patent Application Publication
(10) Pub. No.: US 2006/0000914 A1
(43) Pub. Date: Jan. 5, 2006

(54) Memory card capable of wireless transmission

(76) Inventor: Chien-Yuan Chen, Banchiau City (TW)

Correspondence Address: Power Digital Card Co., Ltd., P. O. Box No. 6-57, Junghe, Taipei, 235, TW

(21) Appl. No.: 10/879,108

(22) Filed: Jun. 30, 2004

(51) Int. Cl. G06K 19/06

(52) U.S. Cl. 235/492

(57) ABSTRACT

A memory card capable of wireless transmission according to the invention includes an attachment adhered to a memory card and made of a non electrically conductive material, an antenna located at one side of the attachment to be adhered to the memory card and made of an electrically conductive material, and an extension connecting wire stretched into the memory card having two ends thereof respectively connected to the electrically conductive material and a printed circuit board, thereby forming a memory card capable of wireless transmission using the memory card integrating the antenna formed by the electrically conductive material.

### BACKGROUND OF THE INVENTION

(a) Field of the Invention

The invention relates to a memory card, and more particularly, to a memory card integrating an antenna made of an electrically conductive attachment and thus forming a memory card capable of wireless transmission.

(b) Description of the Prior Art

Accompanied with blooming of technologies, data access and storage are becoming more and more convenient. For example, fiscards in the earlier days utilize magnetic strips for reading and comparing data, and have evolved into integrated circuit cards. The integrated circuits are for reading and accessing data, so as to ensure that users' information is not leaked out for unlawful purposes.

In prior computers, magnetic strips used for data storage and access are gradually replaced by compact discs that are further developed into memory cards having a capacity of 8MB, or even into current memory cards having capacities as large as 256 MB, 512 MB and up to 1 GB. It is apparent that memory card applications stand as favorites in the information technology era.

However, due to variations in chip formats and circuit configurations, memory cards are available in different standards including SD, MMC, CF, XD, SM, SIM, RS MMC, and Mini SD.

As a result of different standards, the aforesaid memory cards are incompatible when put to use, and significant application restrictions are thus incurred.

Referring to FIG. 1 showing a common SD memory card, the memory card 10 has an input/output interface 14 at one end thereof. When the memory card 10 is used for data access using a card reader or card reading device, it is necessary that the input/output interface 14 come into contact with terminals within the card reader or card reading device in order to read or store data in the memory card 10.

In addition, a card reader or card reading device is required for the memory card 10 to access or store data. That is, in the absence of a card reader or card reading device, access and storage effects of the memory card 10 are considered no longer valid. Again, the need of a card reader or card reading device imposes great restrictions on applications of the memory card 10.

### SUMMARY OF THE INVENTION

The primary object of the invention is to provide a memory card capable of wireless transmission, in that an antenna formed by an electrically conductive material and located at an attachment of the memory card is integrated with the memory card, such that the memory card becomes capable of wireless transmission using the antenna apart from providing data access and storage functions.

To accomplish the aforesaid object, the memory card capable of wireless transmission according to the invention comprises an attachment adhered to the memory card and made of a non electrically conductive material, an antenna located at one side of the attachment to be adhered to the memory card and made of an electrically conductive material, and an extension connecting wire stretched into the memory card and having two ends thereof respectively connected to the electrically conductive material and a printed circuit board, thereby forming a memory card capable of wireless transmission.

### BRIEF DESCRIPTION OF THE DRAWINGS

FIG. 1 shows a schematic view of a prior memory card.

FIG. 2 shows an exploded schematic view according to the invention.

FIG. 3 shows an elevational schematic view according to the invention.

FIG. 4 shows a partial sectional schematic view according to the invention.

FIG. 5 shows a schematic view illustrating transmission according to the invention.

### DETAILED DESCRIPTION OF THE PREFERRED EMBODIMENTS

To better understand contents and effects of the invention, detailed descriptions shall be given with the accompanying drawings below.

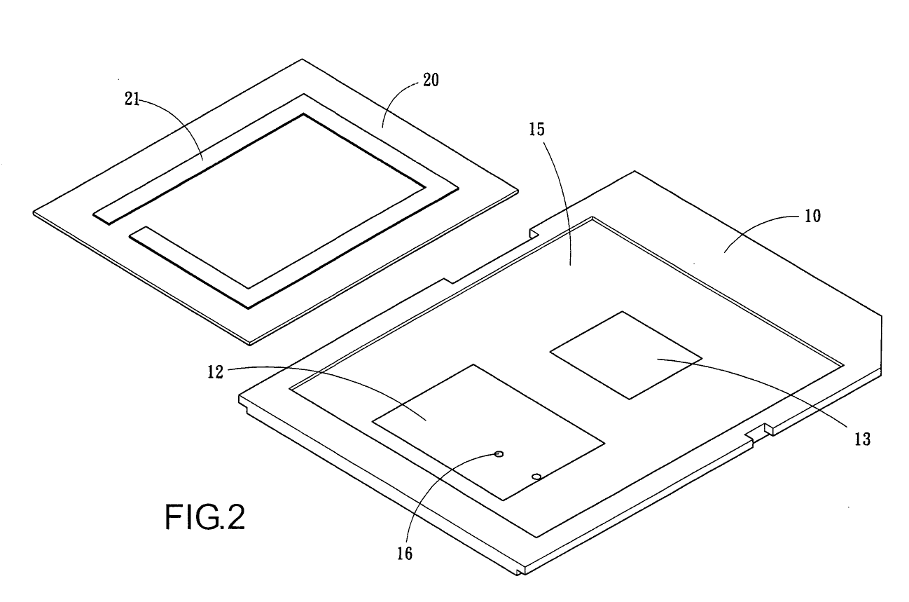

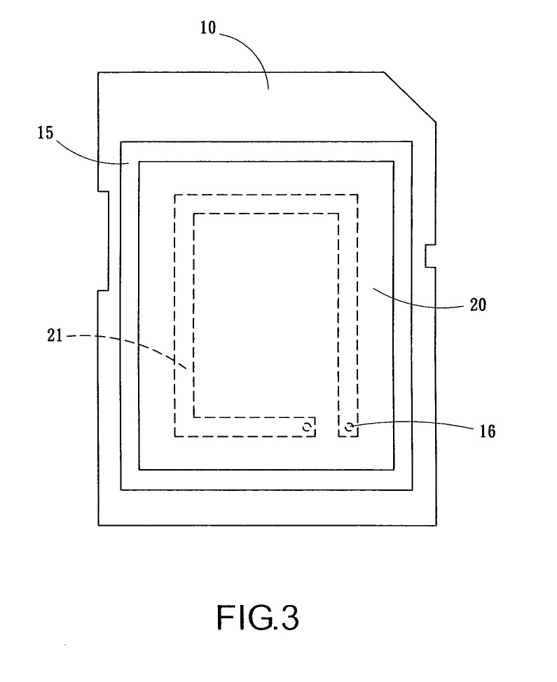

Referring to FIGS. 2 and 3, a memory card capable of wireless transmission according to the invention comprises a memory card 10 and an attachment 20.

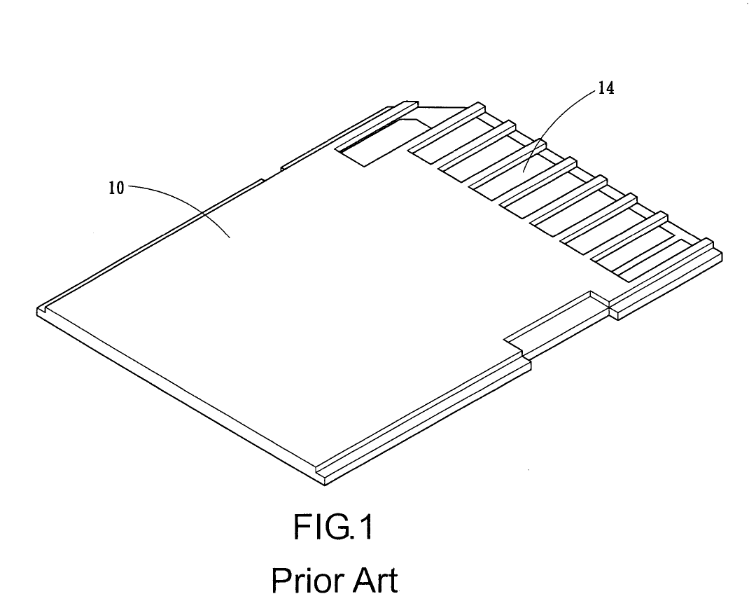

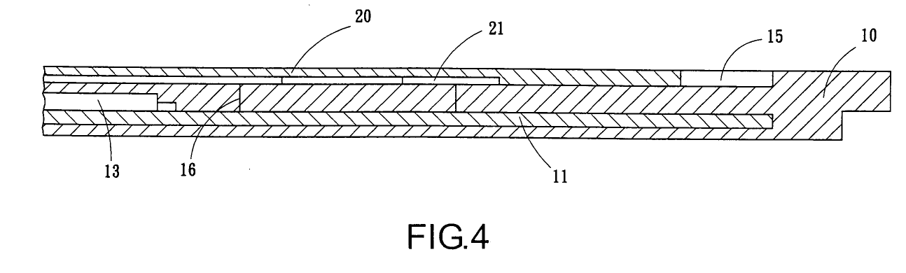

The memory card 10 has a printed circuit board (PCB) 11 at an interior thereof as shown in FIG. 4, a micro processor 12 and a memory 13 at one side of the PCB 11, an input/output interface 14 at the other side of the PCB 11 as shown in FIG. 1, and an adhesion area 15 located at one external side thereof and corresponding with the micro processor 15 and the memory 13. Wherein, the adhesion area 15 has an extension connecting wire 16 stretched into the memory card 10 to connect with the micro processor 12.

The attachment 20 is a non electrically conductive material and is adhered to the adhesion area 15 at the external side of the memory card 10. One side of the attachment 20 that adheres to the adhesion area 15 is provided with an antenna 21, which is made of an electrically conductive material, and is in contact with the extension connecting wire 16 at the memory card 20.

Referring to FIG. 4, when the attachment 20 is adhered to the adhesion area 15 at the memory card 10, the antenna 21 is in contact with one end of the extension connecting wire 16 at the memory card 10, such that the extension connecting wire 16 has one end thereof connected with the antenna 21 and the other end thereof connected with the micro processor 12 in the memory card 10 to form a memory card 20 capable of wireless transmission.

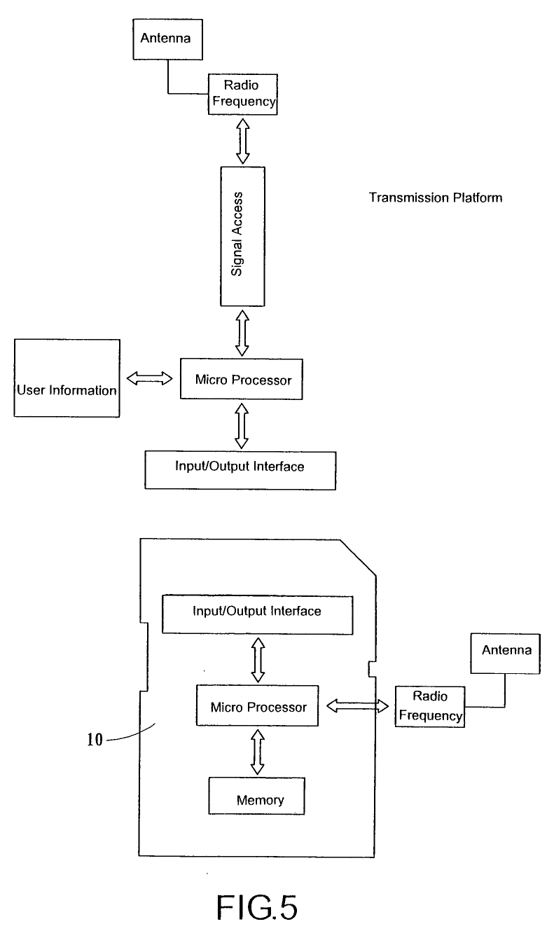

Referring to FIG. 5, to use the memory card 20 for data access and storage with a transmission platform 30, apart from using insertion and connection of the input/output interface 14 with the transmission platform 30, wireless transmission signals from the transmission platform 30 are also transmitted to form connection between the antenna 21 at the memory card 10 with the internal micro processor 12 to further drive the micro processor 12, thereby accessing and storing data in the memory 13.

Meanwhile, the memory card 10 can integrate functions of a SIM card using the antenna 21. Hence, the memory card 10 not only provides data access and storage functions, but can also be inserted to a mobile phone for allowing communication using the mobile phone, or to further transmit data using infrared or Bluetooth.

Moreover, according to the invention, functions of the memory card integrating an antenna can be applied to common integrated circuit cards such as chip cards used for MRT, buses and small-amount spending, linked up with credit cards, or implemented to identification cards, thereby offering vast conveniences to integrated circuit card applications.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A memory card capable of wireless transmission, comprising:
a memory card having a printed circuit board (PCB) at an interior thereof, a micro processor and a memory provided at the PCB, an adhesion area an external side thereof, and an extension connecting wire stretching from the adhesion area into the memory card to connect with the micro processor; and
an attachment adhered to the adhesion area at the external side of the memory card; and an antenna located at one side of the attachment to be adhered to the adhesion area, made of an electrically conductive material, and being in contact with the extension connecting wire at the memory card;
thus, apart from access and storage functions, the memory card integrating the antenna is also capable of wireless transmission.

2. The memory card capable of wireless transmission according to claim 1, wherein the attachment is made of a non electrically conductive material.

3. The memory card capable of wireless transmission according to claim 2, wherein the electrically conductive material is silver adhesive.
